(19) United States
(12) Patent Application Publication
(10) Pub. No.: US 2026/0291393 A1
(43) Pub. Date: Sep. 24, 2026

(54) CIRCUIT ARRANGEMENT FOR A COMPONENT OPERATED IN THE HIGH-VOLTAGE RANGE IN A MOTOR VEHICLE, COMPONENT, AND METHOD FOR OPERATING THE COMPONENT

(71) Applicant: Webasto SE, Stockdorf (DE)

(72) Inventors: Alexander Henne, Stockdorf (DE); Rudolf Haeussermann, Stockdorf (DE)

(21) Appl. No.: 19/573,914

(22) Filed: Mar. 20, 2026

(30) Foreign Application Priority Data
Mar. 20, 2025 (DE) 102025110924.9

(51) Int. Cl. H02M 3/335; B60R 16/023; B60R 16/033

(52) U.S. Cl. CPC H02M 3/33523; B60R 16/0231; B60R 16/033

(57) ABSTRACT

A circuit arrangement for a component operated in a high-voltage range in a motor vehicle, which comprises a low-voltage terminal that can be used to provide an input voltage in a low-voltage range, a DC-DC converter which is configured to convert the input voltage applied to its input into an output voltage at its output, a control apparatus which is connected to the output of the DC-DC converter and is configured to control operation of the component in the high-voltage range, a high-voltage terminal that can be used to provide a current for operating the electrical component in the high-voltage range, and an interlock circuit with an interlock loop, where the interlock circuit is configured to generate an interlock signal depending on a state of a plug connection at the high-voltage terminal.

### CROSS-REFERENCE TO RELATED APPLICATION

This application claims priority to German Application No. DE 102025110924.9 filed on Mar. 20, 2025, which is incorporated herein by reference in its entirety for all purposes.

### TECHNICAL FIELD

Various aspects relate to a circuit arrangement for a component operated in the high-voltage range in a motor vehicle, for example for an electrically operated heater, in which an HV interlock is implemented as a safety measure in order to prevent electric shocks or fires.

### BACKGROUND

It is known to use so-called HV interlocks (high-voltage interlocks) in electrical systems and/or for example also vehicles in order to protect people and equipment from high voltages. The HV interlock is a safety system that continuously monitors, for example, whether all high-voltage components are linked or connected to each other safely (and as prescribed). In the event of an implausible or unexpected connection between components—for example a short circuit due to faulty wiring, damage, or an incorrectly closed circuit—the HV interlock interrupts the current flow in order to prevent danger caused by electric shocks or a fire.

This technology is particularly important in areas such as electromobility (in electric and hybrid vehicles), aviation and aerospace, energy generation and distribution, and industrial applications where high voltage is used. The HV interlock helps to ensure that the safety regulations are complied with and thus protects both operators and the technical equipment.

For example, an HV interlock is used to detect whether or not an HV plug, which connects an electrical component to the high voltage of the electrical power supply of a vehicle, has been inserted into the corresponding socket of the plug connection. In the example, the HV interlock essentially functions as a type of safety circuit that ensures that the high-voltage supply is not activated until the plug has been fully and correctly plugged in and a safe electrical connection has been established.

The HV interlock can be implemented, for example, by means of an interlock loop or an electrical signal path. A (low-voltage) test voltage is applied between two terminals of a line in the component to be connected. The loop extends into the socket, where it is interrupted, thereby forming two signal contacts. An associated connecting line is implemented in the corresponding plug and forms opposite signal contacts. Inserting the plug (correctly) into the socket closes the loop in a similar way to a switch, which can be detected. The result can then be transmitted, for example, via the communication interface to control electronics of the vehicle (e.g. a so-called vehicle control unit, VCU, or a so-called battery management controller, BMC).

When inserting the plug into the corresponding socket, the respective contacts can be arranged in a mechanically resilient and spatial manner in such a way that they are connected in a specific order. As a rule, first the signal contacts and then those power supply contacts which transmit the high voltage are connected. This allows the system to check, for example, whether the plug has been inserted correctly, specifically before the high voltage is activated.

As soon as the control electronics receive the information that a safe connection has been established through the closed signal path, the high-voltage supply is activated. Without this confirmation, the high-voltage release can remain deactivated and no current flows through the plug for high-voltage operation. In addition, continuous monitoring is implemented: during use, the system continuously monitors the state of the interlock signal. If the connection is interrupted during operation (e.g. by partially removing or releasing the plug), the high-voltage supply is immediately interrupted in order to minimize safety risks.

As a result, the HV interlock provides a dual protection function: It prevents high voltage from being activated before a safe connection exists and disables the high-voltage supply if the safe connection no longer exists. This function is of major importance for example for electric vehicles and other high-voltage applications in order to provide protection against electric shocks and to ensure safety.

An example of a component operated with high-voltage current in the vehicle is an electric vehicle heater. Such an electric vehicle heater may have, for example, a control module with an electronic control unit (ECU), a heating module with a number of heating elements designed as heating resistors and a heat exchanger module in which the heat generated by the heating resistors is transferred to a fluid. The heating resistors are operated with the high-voltage current supplied via the HV plug. The electronic control unit, on the other hand, is supplied with current from a low-voltage side. A separate low-voltage plug may be provided for this purpose.

The electronic control unit communicates with the control electronics and/or further control devices in the vehicle via the low-voltage plug, evaluates information received from sensors in the heater, and regulates/controls the operating current through the heating resistors, etc. The heating current can for example also be regulated/controlled in a pulse width-modulated manner via switches or power transistors. To enable this, the microcontroller of the electronic control unit performing this regulation/control can be implemented on the high-voltage side. Power is then supplied from the low-voltage side via a DC-DC converter that is used to convert the input voltage to a potential-isolated control voltage on the output side. For the purpose of system safety, the DC-DC converter is of the galvanically isolated type, e.g. a flyback converter.

In such a design, the HV interlock must be implemented on the low-voltage side—also for system safety reasons. In principle, this would require an independent microcontroller for monitoring the test signal in the interlock loop on the low-voltage side. However, since the control/regulation must be arranged on the high-voltage side, this means that a further module, namely this dedicated microcontroller for the HV interlock, must be implemented, which leads to an increase in components, more space and energy consumption, further process steps during production and thus to higher costs overall.

Alternatively, only the implementation of simple measurement logic on the low-voltage side would also be possible. This could then, e.g. via a digital isolator, digitally transmit the result of the evaluation of the interlock signal (i.e., the interlock loop is detected as closed or open) to the microcontroller on the high-voltage side. As an alternative or in addition to a digital isolator, the use of an optocoupler is also possible for the analogue transmission of the result. In a similar way, however, this also results in the disadvantage that in any case a component part bridging the galvanic isolation is required, which component part entails significant costs and efforts and, in the case of an optocoupler, is also subject to ageing effects, for example.

### SUMMARY

It is therefore an object to eliminate the aforementioned disadvantages and problems, to save costs and material and at the same time to ensure the full functionality and safety of an HV interlock.

Aspects of the disclosure are based on a circuit arrangement for a component operated in a high-voltage range in a motor vehicle, for example for an electrically operated heater. The circuit arrangement comprises a low-voltage terminal that can be used to provide an input voltage in a low-voltage range, e.g. from a low-voltage power source, and a high-voltage terminal that can be used to provide a current with which an actually functional part of the component is to be operated; in the example of the heater, these include one or more heating elements.

Furthermore, the circuit arrangement also has a control apparatus which is configured to control operation of the component in the high-voltage range. These can also be specifically switches or switching elements, for example power transistors (IGBTs, power MOSFETs, etc.), which are controlled. In the embodiment of the heater, these can be used to control the heating power, for example in pulse-width-modulated operation of the heating element(s). The control apparatus may be a microcontroller or may comprise one or more of the same. The control apparatus can be part of an electronic control unit (ECU) of the heater.

The control apparatus is not supplied with power via the high-voltage terminal, but via the low-voltage terminal. As a result, it is activated and ready for operation when the low-voltage terminal has been effectively inserted or connected, and it can accordingly monitor and control the activation of the actual heating operation even if its power supply is signalled and provided via the high-voltage terminal.

However, in order to be able to operate the electronic components, such as for example the circuit breakers, to which voltage in the high-voltage range is applied, the control apparatus itself requires a power supply in the high-voltage range, which should be generated from the low-voltage terminal. The circuit arrangement therefore further comprises a DC-DC converter which is configured to convert the input voltage applied to its input on the low-voltage side into an output voltage at its output on the high-voltage side. According to the present aspects, the control apparatus is connected to the output of the DC-DC converter. The output voltage does not necessarily need to be in the high-voltage range. It may also be significantly lower, e.g. 15 V in a very special exemplary embodiment. However, at least one component part of the component is operated in the high-voltage range and is controlled for this purpose by the control apparatus supplied with the output voltage.

The circuit arrangement also comprises a safety system in the form of an HV interlock circuit with an interlock loop which extends, for example, through at least a part of a plug connection of the high-voltage terminal. The interlock circuit is for example configured to generate an interlock signal depending on a state of the plug connection and, if necessary, to output it in internal vehicle communication. According to one exemplary embodiment, the interlock circuit may for example be configured to generate and if necessary output an interlock signal depending on whether the interlock loop is closed by correctly plugging the plug connection together or is open in the opposite case.

The plug connection can be composed of a plug and a socket, as described at the outset. The loop extends into the relevant socket on the device side, for example, and is interrupted there, in which case signal contacts may be exposed at the ends of the interruption. Corresponding signal contacts that are connected to each other may be arranged in the relevant plug. If the plug has been correctly inserted into the socket and, for example, locked in place or similarly securely fixed, the signal contacts contact each other, with the result that the interruption in the interlock loop is cancelled. From an electronic point of view, this structure acts like a switch in the interlock loop, which is closed when being plugged in and is opened again when being pulled. Implementations of the switching mechanism other than those described are also possible. For example, the plug may have a magnet which acts on a spring-preloaded conductive intermediate piece in the socket in a defined position of the plug with respect to the socket, with the result that the intermediate piece moves into a position bridging the signal contacts and thus closes the switch. The disclosure is not limited to certain implementations of the interlock loop and the interlock switch formed therein.

To ensure that the closing or opening of the interlock switch achieves measurable or capturable quality, the interlock loop can be supplied with a low voltage, e.g. at one terminal of the interlock switch. On the other side of the interlock switch seen from this terminal, a change in the voltage potential present there can therefore be captured when the switch is closed-compared to a state in which the switch is open. The closing or opening of the switch depending on the state of the plug connection can thus lead to a different voltage potential which can be tapped off and finally output in a suitable manner, e.g. after further processing, at a connection point of the interlock circuit depending on the switch state. The internal structure of the interlock circuit can be arbitrary in the generality acceptable here.

The outputting of the interlock signal at the output depending on whether the interlock loop is closed by correctly plugging the plug connector together or is open in the opposite case, as mentioned above by way of example, may involve a signal being output in the one case in which the switch is opened, and no capturable signal being output in the opposite case (switch closed), or vice versa. Two embodiments are described below in this respect. However, a reverse assignment is also possible, or the interlock signal is output in different capturable signal values for both cases.

Characteristic of the aspects proposed here is the fact that the interlock circuit is connected to the DC-DC converter, such that the DC-DC converter outputs an output voltage with a first voltage value or a second voltage value at its output depending on the interlock signal output.

Thus, for transmitting an interlock signal from the low-voltage side to the high-voltage side, a DC-DC converter that is already present in principle is used in order to therefore transmit information about the status of the interlock loop. In this case, for example, there is intervention for example in voltage regulation of the DC-DC converter, such that it outputs a different voltage value at its output on the high-voltage side, depending on the state of the plug connection.

The control apparatus on the high-voltage side is now in turn configured to capture the first and second voltage values and, depending thereon, to output a signal representing the state of the plug connection of the high-voltage terminal. This output can be internal vehicle communication, e.g. via the vehicle electrical system (e.g. CAN bus or the like). Alternatively or additionally, this output may also include an internal device reaction such as deactivation or blocking of components. Alternatively or additionally, this output may also include signalling an internal device reaction in internal vehicle communication or outputting data or warning signals via a display apparatus, etc.

As a result, according to aspects of the disclosure, the circuit parts normally provided in the electrically operated component as such, such as the interlock circuit, the DC-DC converter and the control apparatus, can be used to construct a circuit arrangement from interacting parts which pass information about a state (state of the plug connection) from the low-voltage side via the DC-DC converter to the high-voltage side without the need to implement additional component parts such as a low-voltage-side microcontroller or an optocoupler that overcomes galvanic isolation. This saves costs and effort and reduces the number of parts.

Aspects of the disclosure offer for example the advantage that the interlock can be detected from the high-voltage side without needing to implement additional isolation modules (for the galvanic isolation) or sections. In other words, it is possible to set up the electrically operated component as a single-controller system with only one control apparatus (controller) on the high-voltage side, but which can provide the full interlock functionality without additional costs arising that would be caused by an isolation module such as an additional optocoupler.

Vehicles within the meaning of this application are, for example, motor vehicles (cars), lorries, construction vehicles, aircraft such as aeroplanes or helicopters, spacecraft, ships and boats.

The disclosure can be advantageously implemented in all components operated in a high-voltage range, for example in a heater as an electrically operated component. Electrically operated heaters for example come into consideration as high-voltage applications that provide their own ECU for communication and control, which is fed from a low-voltage source and which also communicates via the low-voltage terminal.

In exemplary embodiments, low voltage can denote, for example, a range of up to max. 12 to 14 V (e.g. terminal 30). However, the low-voltage range can also extend up to 60 V, for example. High voltage denotes, for example, a range of 60 to 1500 V. According to the generalized concept of the disclosure, the ranges may also overlap in principle. The relationship between the specific low voltage and the specific high voltage is not functionally decisive for the present aspects. However, an important feature in the present case is that the two voltage ranges are potential-isolated. From a functional point of view, the low-voltage range is used, for example, for signalling, communication and measurement. In addition to control and regulation tasks, the high-voltage range also serves to operate at least one component part of the component in a high-voltage range with a voltage of greater than 60 V, for example with 250 V, 400 V or 800 V, depending on which high voltage can be provided by a vehicle as a supply.

According to one development, the DC-DC converter is of the type of a galvanically isolated DC-DC converter. The galvanic isolation provided by such DC-DC converters is an important building block for the safety of the system. It prevents, in the event of failure of the insulation and/or short circuits, high voltages from spreading to parts which could be touched by persons with the risk of injuries or which, as electronic component parts, themselves cannot withstand these voltages, with the risk of fires or irreparable excessively costly damage.

The DC-DC converter can preferably be a flyback converter. However, forward converters, push-pull converters, resonant converters etc. can also be used as DC-DC converters with galvanic isolation according to embodiments.

According to one embodiment, the DC-DC converter has a low-voltage-side primary circuit, a high-voltage-side secondary circuit, a switching regulator which controls a switch in the primary circuit, and a feedback path, via which a signal with information about a present output voltage is fed back to the switching regulator. The DC-DC converter can therefore preferably be a regulated DC-DC converter. In this embodiment, the connection point of the interlock circuit is also connected via the feedback path to the switching regulator in order to vary the fed-back signal depending on the interlock signal. In other words, the interlock circuit is configured to intervene in the regulation of the DC-DC converter and to thereby affect its output voltage, which in turn can be detected by the high-voltage-side control apparatus.

According to a special development, it is preferred for the feedback path to be divided by galvanic isolation into a low-voltage-side path section and a high-voltage-side path section. This means that the feedback path, like e.g. the storage transformer of the converter, bypasses the galvanic isolation or also itself takes it into account again. In this case, the connection point of the interlock circuit is connected to the low-voltage-side path section. Thus, the interlock circuit is completely on the low-voltage side. The galvanic isolation with information transmission (interlock: yes or no) to the high-voltage side is therefore completely taken over by the DC-DC converter. Since the DC-DC converter is provided anyway, the interlock circuit only needs to dock to the feedback path without a need to change the components in the DC-DC converter.

According to a special embodiment, the galvanic isolation between the low-voltage-side path section and the high-voltage-side path section of the feedback path can be effected by means of an optocoupler. It should be noted here that this optocoupler may have to be provided for the DC-DC converter anyway. The disclosure rather saves a second optocoupler in this case, which would conventionally need to be used between the interlock circuit and the high-voltage-side controller.

Regulation by means of feedback of the present output voltage is basically advantageous, since the regulation can itself be based directly on the variable to be set. An optocoupler can guarantee this, but the disadvantage is that an optocoupler is subject to ageing effects.

In an alternative embodiment, in the circuit arrangement, the DC-DC converter (again) has a low-voltage-side primary circuit, a high-voltage-side secondary circuit, a switching regulator which controls a switch in the primary circuit, and a feedback path, via which, however, a signal with information about a present voltage is now fed back from an additional measurement winding on a storage transformer of the DC-DC converter to the switching regulator. In this case, the feedback in the control loop is therefore effected indirectly based on variables that are only related to the output voltage to be set, but do not directly depend on the output voltage Ua. This can thus result in a slight error in the regulation, but the optocoupler can be omitted, which reduces the costs and number of component parts, and improves durability, for example the service life.

Here too, however, as in the above embodiment, the connection point of the interlock circuit is connected via the feedback path to the switching regulator in order to influence the fed-back signal in a detectable manner depending on the interlock signal.

According to a further embodiment, the interlock circuit has at least one transistor, the gate or base terminal of which is connected to the interlock loop (for example to the interlock switch which can be realized by the interruption and the contacts in the plug connection), and the drain or collector terminal of which and the source or emitter terminal of which in the electrically conductive case each accordingly connect the connection point of the interlock circuit or the feedback path to the ground potential. This is a particularly simple implementation of an HV interlock circuit.

The transistor can be a MOSFET or a bipolar transistor, for example. The interlock loop can be used to switch the transistor which thereby, for example, pulls the corresponding path section of the feedback path to a comparatively lower potential (e.g. transistor on if the interlock loop is closed or the plug is inserted correctly) or leaves it unaffected (transistor off if the interlock loop is open or the plug is pulled).

In a further embodiment, the control apparatus is configured to compare the first and second voltage values with a predetermined reference value or with a predetermined reference interval and, depending on the result, to output the signal representing the state of the plug connection of the high-voltage terminal. Since slight variations can be expected when regulating the clocking or the duty cycle of the switch(es) of the DC-DC converter, which are compensated by the regulation, for example in the event of load changes on the high-voltage side, it may be advantageous to specify a voltage range for the interlock detection, within which the measured output voltage should lie, depending on whether or not the plug connection has been correctly inserted. The extent of the influence of the feedback path should therefore also be sufficiently large so that these two voltage ranges can be selected at a sufficient distance from each other, but possibly also at a distance which is not too large, so that the control apparatus or the corresponding microcontroller still remains operational at both voltage levels.

According to exemplary embodiments, the first voltage value may correspond to a state in which the plug connection at the high-voltage terminal has been correctly established and the operation of the component has been activated or must be activated; and the second voltage value may correspond to a state in which the plug connection has not been established correctly or at all and the intended operation of the component has been blocked or must be blocked.

As described, provision is also made according to exemplary embodiments for the control apparatus to output the signal representing the state of the plug connection of the high-voltage terminal to control electronics, a battery management system or another electronic control unit in the vehicle digitally via a vehicle bus. Furthermore, the signal representing the state of the plug connection of the high-voltage terminal may include deactivation of the high-voltage operation of the electrically operated component via the high-voltage terminal, if necessary also without communication to the outside being carried out.

Further advantages, features and details of the various aspects can be gathered from the claims, the following description of preferred embodiments as well as on the basis of the drawings. In the figures, the same reference signs denote the same features and functions.

### BRIEF DESCRIPTION OF THE DRAWINGS

In the drawings:

FIG. 1 shows a circuit diagram of a circuit arrangement according to a first exemplary embodiment;

FIG. 2 shows a circuit diagram of a circuit arrangement according to a second exemplary embodiment.

### DETAILED DESCRIPTION

In the following description of preferred exemplary embodiments, it should be taken into consideration that the present disclosure of the various aspects is not limited to the details of the structure and the arrangement of the components illustrated in the following description and in the figures. The exemplary embodiments can be implemented or carried out in various ways in practice. It should also be taken into consideration that the wording and terminology used here is used merely for the purpose of the specific description and should not be interpreted restrictively as such by a person skilled in the art. In addition, in the following description, the same reference signs in the various exemplary embodiments or figures denote the same or similar features or objects, and therefore in some cases a repeated detailed description of them is omitted in order to maintain the compactness and clarity of the illustration.

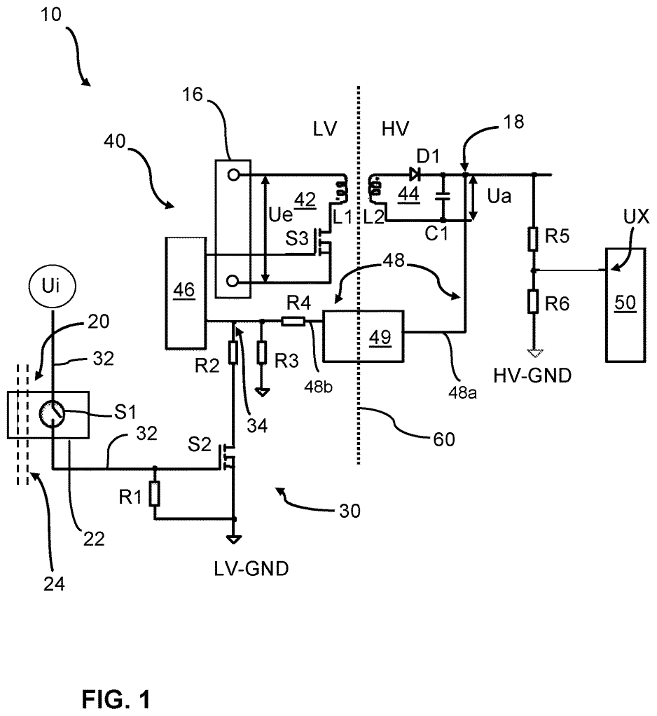

FIG. 1 shows a circuit diagram of a circuit arrangement 10 for an electrically operated heater 1 according to a first exemplary embodiment. The circuit arrangement 10 essentially comprises an HV interlock circuit 30, a DC-DC converter 40 and a control apparatus 50, which are described below. In addition, a low-voltage terminal 16 and a high-voltage terminal 20 are provided therein. However, the high-voltage terminal 20 as such merely provides an HV power supply for operating heating elements in the heater, which is not part of the circuit arrangement 10 considered in FIG. 1. Therefore, the corresponding HV lines are only schematically indicated in FIG. 1. However, the low-voltage terminal 16 and the high-voltage terminal 20 are each assigned plug connectors, of which only the high-voltage plug connector 22 is shown schematically as a box in FIG. 1. Mechanically, the plug connector 22 is designed as a plug and socket. It is provided with an HV interlock in order to meet the requirements for safety described above.

The interlock circuit 30 is configured for this purpose. The interlock circuit 30 is formed as a module of electronic components, which generates a signal, here called the interlock signal, on a low-voltage side LV depending on whether or not the plug has been correctly inserted into the socket of the plug connector, so that a reliable electrical connection in the HV circuit can be ensured, and which transfers this signal for forwarding to a high-voltage side HV that is galvanically isolated from the low-voltage side LV. In the special exemplary embodiment in FIG. 1, the interlock circuit 30 comprises an interlock loop 32 which extends into the plug connector 22 and is interrupted when the plug has been pulled or has not been correctly inserted, while the connection of the interrupted loop parts is closed when the plug has been correctly inserted. The interlock loop 32 is supplied on one side by a test voltage source Ui with a low voltage, e.g. 5 V, which is generated from the low-voltage terminal 16 (not shown). The interruption of the loop parts of interlock loop 32 and the connection of appropriately configured electrical contacts by means of a plug-side conductive intermediate piece acts like an electrical switch S1 which is manually actuated by inserting the plug (and can also be opened again by pulling it).

Opposite the test voltage source Ui with respect to the switch S1, the interlock loop 32 is connected to the low-voltage-side ground potential LV_GND via a high-value resistor R1. Between this resistor R1 and the switch S1 formed by the plug connector, a tap of the interlock loop 32 is formed with a connection to a gate of an n-channel MOSFET as a second switch S2 in the interlock circuit 30. Depending on the voltage potential present at the gate, this second switch S2 can open or close a connection between the ground potential LV_GND and a connection point 34 of the interlock circuit 30, wherein a resistor R2 is also interposed between the connection point 34 and the collector of the n-channel MOSFET. The connection point 34 of the interlock circuit 30 is simultaneously a connection point in a feedback path 48 of the regulated DC-DC converter 40. It follows from this that, depending on the state of the plug connection or the plug connector (correctly inserted or not), the second switch opens or closes the connection between the connection point 34 and the ground potential LV_GND, which has different effects on the signal level returned in the feedback path 48.

The DC-DC converter 40 is designed as a flyback converter and comprises a primary circuit 42 with a third switch S3, a secondary circuit 44 with a diode D1 and a storage capacitor C1, the feedback path 48 and a switching regulator 46. The primary circuit is supplied with an input voltage Ue from the low-voltage terminal 16. Intermediate filters, bridges, etc. are not shown. The input voltage Ue can also be reduced or otherwise changed compared to the low voltage supplied via the low-voltage terminal 16. Further components that have been omitted in the simplified illustration, for example a main inductance, may also be set up in the flyback converter. The primary circuit 42 and the secondary circuit 44 are connected in a known manner via a storage transformer to windings L1 and L2 around a core with an air gap. In the high-frequency-clocked operation of the third switch S3, which is controlled by the switching regulator 46, the closed third switch S3 charges the storage transformer, while its stored energy is transferred to the secondary side in the open state of the third switch S3. The storage transformer enables galvanic isolation 60 between the low-voltage side LV and the high-voltage side HV. The galvanic isolation is symbolically illustrated by a dashed line. The storage capacitor C1 in the secondary circuit ensures a temporally smoothed output voltage Ua at the output 18 of the DC-DC converter and the diode D1 in the secondary circuit prevents an intermediate discharge of the storage capacitor C1. In this configuration, the output voltage Ua is higher than the input voltage Ue, but is not equal to that high voltage which is supplied for the actual heating power via the high-voltage terminal 20 or the plug connector 22. Purely by way of example, the output voltage can be 15 V and the high voltage can be 250 V.

A tap for the feedback path 48 is set up at the output 18 of the DC-DC converter 40. The feedback path 48 returns information about the output voltage Ua from the secondary side 44 to the primary side 42 and allows the operation of the third switch S3 to be regulated by the switching regulator 46 via this feedback in order to maintain a predetermined value for the output voltage Ua. The galvanic isolation 60 is here ensured by an optocoupler 49 in the feedback path 48. The optocoupler 49 thus divides the feedback path 48 into a low-voltage-side path section 48b and a high-voltage-side path section 48a. The low-voltage-side path section 48b establishes the connection between the optocoupler 49 and an input of the switching regulator 46 via a resistor R4.

The connection point 34 of the interlock circuit 30 is connected to this low-voltage-side path section 48b. The low-voltage-side path section 48b is connected to the low-voltage-side ground potential LV_GND via a resistor R3. The connection between the connection point 34 of the interlock circuit 30 and the low-voltage-side ground potential LV_GND, including the resistor R2 provided therein, is arranged parallel to the connection to the ground potential via the resistor R3.

In other words, if the plug connection 22 has been inserted correctly, the second switch S2 is turned on and the low-voltage-side path section 48b is connected to the low-voltage-side ground potential LV_GND via both resistors R2 and R3. If, on the other hand, the plug connection 22 has not been inserted correctly or at all, the second switch S2 is turned off and the low-voltage-side path section 48b is only connected to the low-voltage-side ground potential LV_GND via the resistor R3. The switching regulator 46 will therefore detect a higher voltage level at its input in the second case than in the former case. As a result, in the second case, it will set reduced clocking or a lower duty ratio, which results in a lower output voltage Ua at the output 18. This is dimensioned (e.g. via the suitable selection of the resistors R2 and R3) such that the control apparatus 50 connected to the output 18 is also operational at this output voltage Ua.

However, in the former case-when the plug connection 22 is correctly inserted-a load is applied at the connection point 34 with the result of a comparatively lower voltage level at the input of the switching regulator 46. As a result, in the second case, the switching regulator 46 will set increased clocking or a higher duty ratio, which results in a higher output voltage Ua at the output 18.

A voltage divider formed by the resistors R5 and R6 can be used to capture the divided output voltage Ua via a measurement input UX of the control apparatus and to compare it with a reference voltage. Depending on the result of the comparison, the control apparatus 50 can therefore determine whether or not the switch S1 is closed, i.e. whether or not the plug connector 22 has been correctly inserted. Depending on this result, the control apparatus 50 can signal to control electronics or a BMC or another ECU that the heater (the component) is ready for use or that there is a problem. Further, the control apparatus 50 can activate or deactivate components or circuit parts internally depending on the interlock signal.

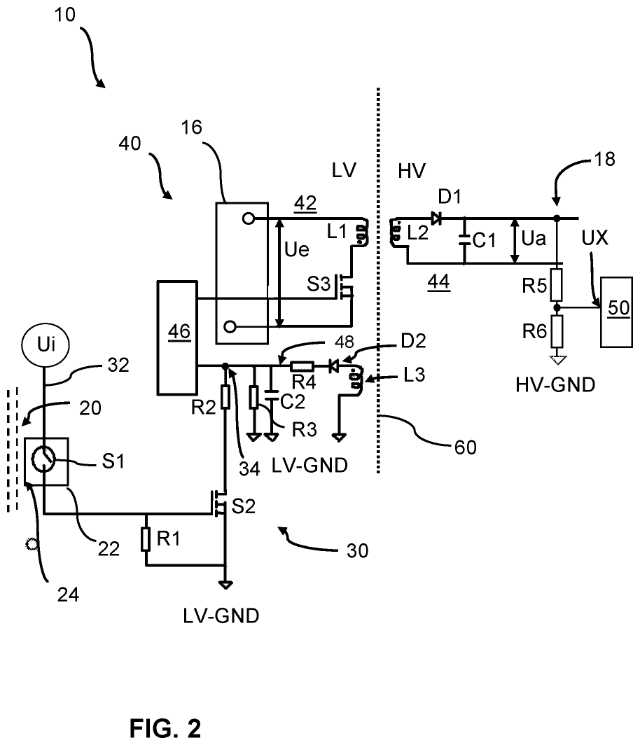

FIG. 2 shows, with reference to a second exemplary embodiment, a minor modification of the first exemplary embodiment shown in FIG. 1. Only the differences from the first exemplary embodiment are considered. For example, the function and the structure of the interlock circuit 30 and of the DC-DC converter 40 (flyback converter) and the control apparatus 50 are more or less identical to the first exemplary embodiment.

In contrast to the first exemplary embodiment, in addition to a first winding L1 in the low-voltage-side primary circuit 42 and a second winding L2 in the high-voltage-side secondary circuit, an additional measurement winding L3 is wound on the storage transformer of the DC-DC converter 40 in the DC-DC converter. During operation of the flyback converter, a smoothing capacitor C2 connected to the measurement winding L3 via a feedback path 48 and connected between the feedback path and the low-voltage-side ground potential LV_GND is charged. In a similar manner to how energy is transferred from the storage transformer to the secondary circuit in the operation of the flyback converter described above, this also takes place-albeit to a much lesser extent-into the feedback path 48.

In a similar manner to that in the first exemplary embodiment, the feedback path 48 is connected to a terminal of the switching regulator 46. The voltage level smoothed by the smoothing capacitor C2 on the feedback path 48 is a variable that is representative of the output voltage Ua achieved in the secondary circuit. As a result, it is possible for the switching regulator 46 to regulate the output voltage on the basis of the corresponding feedback through the measurement winding L3.

The interlock circuit 30 now accesses this feedback path 48 by means of the connection point 34 in the same manner as in the first exemplary embodiment. The voltage level on the feedback path 48 during operation of the flyback converter now depends on whether the feedback path 48 is connected to the low-voltage-side ground potential LV_GND solely via the resistor R3 or additionally also via the resistor R2 of the interlock circuit 30, because the switch S2 establishes the corresponding parallel connection to the low-voltage-side ground potential LV_GND as described above due to the correctly inserted plug connection 22. The then different output voltages Ua on the secondary side are then captured using the control apparatus 50, as described above.

The information and details provided in the special exemplary embodiments should not be interpreted in a restrictive manner with respect to the scope of protection specified in the appended claims. Further modifications are therefore also possible. Thus, by a suitable selection and arrangement of the transistor for the second switch S2, the enabling (closing) of the connection between the feedback path 48 and the low-voltage-side ground potential LV_GND can also be carried out in exactly the opposite way, namely in a state of the plug connection in which a correct connection has not been established. In this case of the incorrect connection, the output voltage Ua would then be increased compared to that which would be present in the case of the correct connection. Only the distinctiveness of the two voltage values of the output voltage is therefore important.

Alternative arrangements of the interlock circuit 30, even without transistors for the second switch S2, are also possible, for example the use of a reference diode, or the connection between the feedback path 48 or the connection point 34 and the low-voltage-side ground potential LV_GND takes place directly through the interlock loop 32, with the result that the first switch S1 formed by the contacts in the plug and the socket of the plug connection 22 itself directly influences the voltage level at the connection point 34.

In a corresponding embodiment, the second switch S2 and its ground reference may be omitted, for example, in FIG. 1 or 2. Instead of the test voltage supply Ui (or the supply of the interlock signal on the line 32), the ground potential can be connected there. Then, closing the first switch S1 (interlock switch) with the interlock correctly inserted causes the connection point 34 (HV interlock circuit) to be pulled to ground via the resistor R2. As a result, the intrinsically finely sensitive feedback signal from the DC-DC converter could be switched relatively hard via the mechanical interlock plug, but the comparatively high-value resistor R2 limits any interference. In this embodiment, therefore, the first and second switches coincide.

In an alternative embodiment, instead of being represented by a bipolar or MOSFET transistor, the second switch may also be represented by a reference diode, as offered, for example, as component part TL431 by Texas Instruments. This is a diode with an adjustable reference voltage. The anode of this reference diode is connected in FIG. 1 or 2 in this case to the low-voltage-side ground potential LV-GND, the cathode is connected to the ohmic resistor R2, and the reference input is connected to the interlock switch S1. As soon as a certain voltage is applied to the corresponding reference input of the reference diode as the second switch S2, the diode connects the cathode to ground. In this case, the reference voltage would then be set to Ui which is present when the interlock switch S1 is correctly closed. As a result, the connection point 34 (HV interlock circuit) is pulled to ground potential LV-GND via the resistor R2 via the reference diode.

Further modifications concern other types of DC-DC converters that allow potential isolation.

LIST OF REFERENCE SIGNS:

| | |
|---|---|
| 1 | Electrically operated heater |
| 10 | Circuit arrangement |
| 16 | Low-voltage terminal |
| 18 | Output of the DC-DC converter |
| 20 | High-voltage terminal |
| 22 | Plug connection (high-voltage terminal) |
| 24 | HV lines (power supply for HV load via HV plug connector) |
| 30 | (HV) Interlock circuit |
| 32 | (HV) Interlock loop |
| 34 | Connection point (HV interlock circuit) |
| 40 | DC-DC converter, flyback converter |
| 42 | Primary circuit |
| 44 | Secondary circuit |
| 46 | Switching regulator |
| 48 | Feedback path |
| 48a | High-voltage-side path section |
| 48b | Low-voltage-side path section |
| 49 | Optocoupler of the DC-DC converter |
| 50 | Control apparatus (HV microcontroller) |
| 60 | Galvanic isolation |
| C1 | Storage capacitor |
| C2 | Smoothing capacitor |
| D1 | Diode in the secondary circuit |
| D2 | Diode in the feedback path |
| HV | High-voltage side |
| LV | Low-voltage side |
| L1-L3 | Coils/windings of the storage transformer |
| R1-R6 | Resistors |
| S1 | Interlock switch in the plug connector |
| S2 | Switch in the interlock circuit |
| S3 | Switch in the DC-DC converter |
| Ua | Output voltage of the DC-DC converter (HV) |
| Ue | Input voltage of the DC-DC converter (LV) |
| Ui | Test voltage/test voltage source |
| UX | Measurement input (measure HV output voltage) |

1. A circuit arrangement for a component operated in a high-voltage range in a motor vehicle, comprising:
a low-voltage terminal which is configured to provide an input voltage in a low-voltage range;
a DC-DC converter which is configured to convert the input voltage applied to its input into an output voltage at its output,
a control apparatus which is connected to the output of the DC-DC converter and is configured to control operation of the component in the high-voltage range;
a high-voltage terminal which is configured to provide a current for operating the electrical component in the high-voltage range;
an interlock circuit with an interlock loop, wherein the interlock circuit is configured to generate an interlock signal depending on a state of a plug connection at the high-voltage terminal;
wherein the interlock circuit is connected to the DC-DC converter, such that the DC-DC converter outputs an output voltage with a first voltage value or a second voltage value at its output depending on the interlock signal generated; and
wherein the control apparatus is configured to capture the first and second voltage values and, depending thereon, to output a signal representing the state of the plug connection at the high-voltage terminal.

2. The circuit arrangement according to claim 1, wherein
the input and the output of the DC-DC converter are galvanically isolated.

3. The circuit arrangement according to claim 1, wherein
the DC-DC converter is a flyback converter.

4. The circuit arrangement according to claim 2, wherein
the DC-DC converter has a low-voltage-side primary circuit, a high-voltage-side secondary circuit, a switching regulator which controls a switch in the primary circuit, and a feedback path, via which a signal with information about a present output voltage is fed back to the switching regulator, and
a connection point of the interlock circuit, at which the interlock signal can be generated, is connected via the feedback path to the switching regulator in order to vary the fed-back signal depending on the interlock signal.

5. The circuit arrangement according to claim 4, wherein
the feedback path is divided by galvanic isolation into a low-voltage-side path section (and a high-voltage-side path section, and
the output of the interlock circuit is connected to the low-voltage-side path section.

6. The circuit arrangement according to claim 5, wherein
the galvanic isolation between the low-voltage-side path section and the high-voltage-side path section of the feedback path is effected by an optocoupler.

7. The circuit arrangement according to claim 2, wherein
the DC-DC converter has a low-voltage-side primary circuit, a high-voltage-side secondary circuit, a switching regulator which controls a switch in the primary circuit, and a feedback path, via which a signal with information about a present voltage of an additional measurement winding on a transformer of the DC-DC converter is fed back to the switching regulator, and
a connection point of the interlock circuit, at which the interlock signal can be generated, is connected via the feedback path to the switching regulator in order to vary the fed-back signal depending on the interlock signal.

8. The circuit arrangement according to claim 4, wherein
the interlock circuit has at least one transistor, the gate or base terminal of which is connected to the interlock loop, and the drain or collector terminal of which and the source or emitter terminal of which in the electrically conductive case each accordingly connect the connection point of the interlock circuit or the feedback path to the ground potential.

9. The circuit arrangement according to claim 1, wherein
the control apparatus is configured to compare the first and second voltage values with a predetermined reference value or with a predetermined reference interval and, depending on the result, to output the signal representing the state of the plug connection of the high-voltage terminal.

10. The circuit arrangement according to claim 9, wherein
the control apparatus outputs the signal representing the state of the plug connection of the high-voltage terminal to control electronics, a battery management system or another electronic control device in the vehicle, via a vehicle bus.

11. The circuit arrangement according to claim 1, wherein
the first voltage value corresponds to a state in which the plug connection at the high-voltage terminal has been correctly established and the operation of the component in the high-voltage range has been activated or must be activated; and
the second voltage value corresponds to a state in which the plug connection has not been established correctly or at all and the operation of the component in the high-voltage range has been blocked or must be blocked.

12. A component having at least one component part configured for operation in a high-voltage range, comprising a circuit arrangement comprising:
a low-voltage terminal which is configured to provide an input voltage in a low-voltage range;
a DC-DC converter which is configured to convert the input voltage applied to its input into an output voltage at its output,
a control apparatus which is connected to the output of the DC-DC converter and is configured to control operation of the component in the high-voltage range;
a high-voltage terminal which is configured to provide a current for operating the electrical component in the high-voltage range;
an interlock circuit with an interlock loop, wherein the interlock circuit is configured to generate an interlock signal depending on a state of a plug connection at the high-voltage terminal;
wherein the interlock circuit is connected to the DC-DC converter, such that the DC-DC converter outputs an output voltage with a first voltage value or a second voltage value at its output depending on the interlock signal generated;
wherein the control apparatus is configured to capture the first and second voltage values and, depending thereon, to output a signal representing the state of the plug connection at the high-voltage terminal; and
wherein the at least one component part is a heating element.

13. A method for operating a component in the high-voltage range, comprising:
providing an input voltage in a low-voltage range at a low-voltage terminal;
applying the input voltage to an input of a DC-DC converter;
converting the input voltage into an output voltage at an output of the DC-DC converter;
controlling operation of the component in the high-voltage range by means of a control apparatus connected to the output of the DC-DC converter;
providing a current for operating the electrical component in the high-voltage range by way of a high-voltage terminal;
generating an interlock signal by way of an interlock circuit with an interlock loop depending on a state of a plug connection at the high-voltage terminal;
outputting an output voltage with a first voltage value or a second voltage value at a connection point of the interlock circuit with the DC-DC converter depending on the interlock signal generated; and
capturing the first and second voltage values by way of the control apparatus and, depending thereon, outputting a signal representing the state of the plug connection at the high-voltage terminal.
